(19) United States
(12) Patent Application Publication
(10) Pub. No.: US 2003/0112975 A1
(43) Pub. Date: Jun. 19, 2003

(54) Transmission-reception method for a wireless device of an electronic equipment

(75) Inventor: Vam Chang Taiwanese, Taipei (TW)

Correspondence Address: BACON & THOMAS, PLLC, 625 SLATERS LANE, FOURTH FLOOR, ALEXANDRIA, VA, 22314

(73) Assignee: Inventec Corporation, Taipe, Taiwan

(21) Appl. No.: 10/014,599

(22) Filed: Dec. 14, 2001

(51) Int. Cl. H04K 1/00

(52) U.S. Cl. 380/270

(57) ABSTRACT

A transmission-reception method for a wireless device of an electronic equipment, wherein a control circuit of the device is capable of receiving signals outputted from the equipment and utilizing an encryption-decryption module to encrypt a signal based on a preset identification code. After completing the encryption, the signal is sent by a wireless transceiver module to a remote transmission-reception device. When the device receives an acknowledgment signal from the wireless transceiver module, the acknowledgment signal is decrypted by the encryption-decryption module to determine whether matching with a preset identification number. If positive, sent the acknowledgment signal to the equipment for further processing to achieve the objective of wireless transmission.

### BACKGROUND OF THE INVENTION

1) Field of the Invention

The invention herein relates to a method of communications for an electronic equipment interfacing, specifically to a transmission-reception method for a wireless device of an electronic equipment.

2) Background of the Invention

Conventionally, information is conveyed between computer main systems and peripheral equipment such as printers, video display units, modems, and scanners through numerous data cables. As indicated in FIG. 1, in addition to its power cord, the main system is also connected to several peripherals, which results in a confusing array of cables at the input-output ports of the main system. In addition, since installation space may be limited or the length of data cables available on the market is insufficient, most peripherals must be situated close to the main system to achieve interconnection.

Although wireless transmission devices have been developed in recent years, including those based on the infrared transmission technology now common in the industry (as shown in FIG. 1), are a solution to the said problem, often only newer equipment feature the said technology. However, if all existent equipment were deemed obsolete and replaced for convenience and appearance sake, additional cost would be entailed. Furthermore, we have discovered that while such wireless transmission devices are frequently built into main systems, many peripherals lack this capability, which renders the wireless transmission device of main system useless.

Even if all equipment had infrared transmission capability, the effective range of current infrared transmission technology is only one to two feet. Furthermore, since transmission occurs in a straight line, line-of-sight positioning is required for successful transmission and the angle of deviation must be maintained within plus or minus 15 degrees. As a result, transmission and remote control capability is loss due to environmental constraints as well as the layout or varying angles at which computer peripherals are positioned. Moreover, the transmission coverage only accommodates a one-to-one arrangement and, furthermore, there is no security during transmissions and transmitted data is easily accessed.

With conventional data transmission methods, cabling is disorderly and unlabelled so it is virtually impossible to discern peripheral equipment connections. Furthermore, an overwhelming majority of electronic equipment do not have built-in wireless transmission devices and total replacement would be unfeasible due to cost considerations. Additionally, there is no distributed simplex or multiplex omni-directional transmission capability. In view of the inconveniences and shortcomings resulting from the said situation, the inventor of the invention herein conducted extensive long-term research and experimentation that culminated in the successful development of the electronic equipment wireless transmission-reception device of the invention herein. The said transmission-reception device is connected to the input-output ports of electronic equipment and through wireless communications technology provides for the wireless transmission of digital data between various electronic equipment (such as printers, computer main systems, digital cameras, and scanners, etc.)

### SUMMARY OF THE INVENTION

An objective of the invention herein is to provide a transmission-reception method for a wireless device of an electronic equipment, wherein the control circuit of the said transmission-reception device is capable of receiving signals outputted from electronic equipment. The said control circuit then utilizes an encryption-decryption module to encrypt a signal based on a preset identification code assigned to the transmission-reception device of the said electronic equipment. Following the completion of encryption, the signal is sent by a wireless transceiver module to a remote transmission-reception device of an identical structure. When the said transmission-reception device receives an acknowledgment signal from its wireless transceiver module, the said encryption-decryption module is utilized to decrypt the said acknowledgment signal. Referencing a preset identification number, the said acknowledgment signal is checked to determine whether it has a matching identification code. If the acknowledgment signal has a matching identification code, it is sent to the control circuit assigned the said identification code for further processing such that the electronic equipment achieves the objective of wireless transmission. As such, the electronic equipment units are inter-linked into a wireless area network without the use of physical conductors, thereby effectively replacing confusing, unlabelled data cables and saving installation time and cost.

Another objective of the invention herein is to provide a transmission-reception method for a wireless device of an electronic equipment in which the said control circuit is wired to a communications plug and the other end of the said communications plug is connected to the said electronic equipment to thereby enable the forwarding of signals between the said transmission-reception device and the electronic equipment through the said communications plug. The other end of the said communications plug wired to the control circuit is in connection with the terminals of a communications card. The said communications card has a connector at its opposite end and the said connector is capable of being interfaced with various connectors of different specifications to thereby achieve plug-in interchangeability. As such, projecting technological obsolescence and replacement is no longer a necessary major deliberation and electronic equipment not originally designed with wireless transmission capability can be retrofitted to have wireless transmission capacity.

### BRIEF DESCRIPTION OF THE DRAWINGS

FIG. 1 is an isometric drawing of a conventional wired signal transmission arrangement.

FIG. 2 is an isometric drawing of a conventional wireless infrared signal transmission arrangement.

FIG. 3 is a block diagram of the invention herein.

FIG. 4 is a flowchart of the signal transmission process of the invention herein.

FIG. 5 is a flowchart of the signal reception process of the invention herein.

FIG. 6 is an isometric drawing of an embodiment of the invention herein.

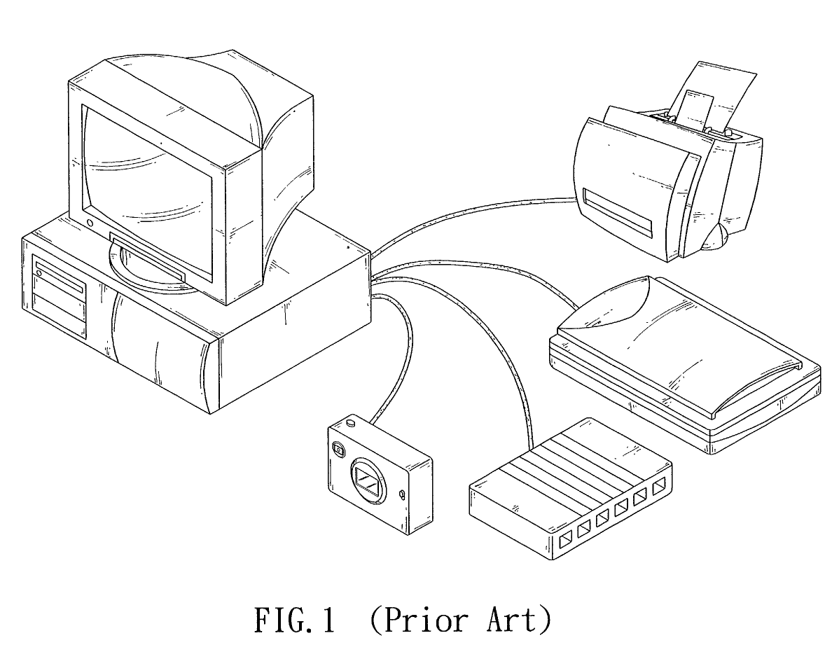

### DETAILED DESCRIPTION OF THE INVENTION

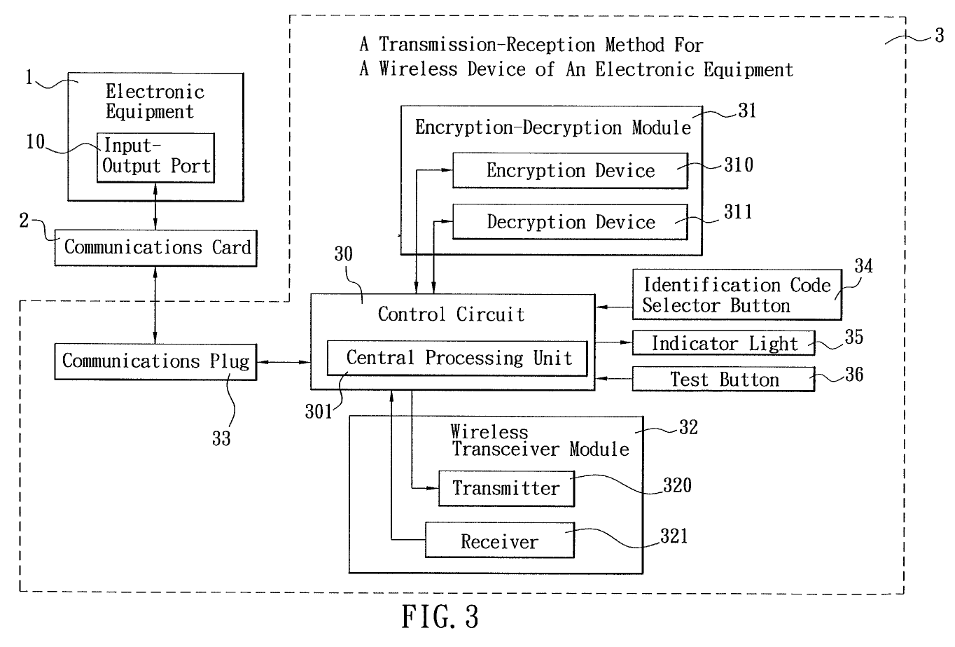

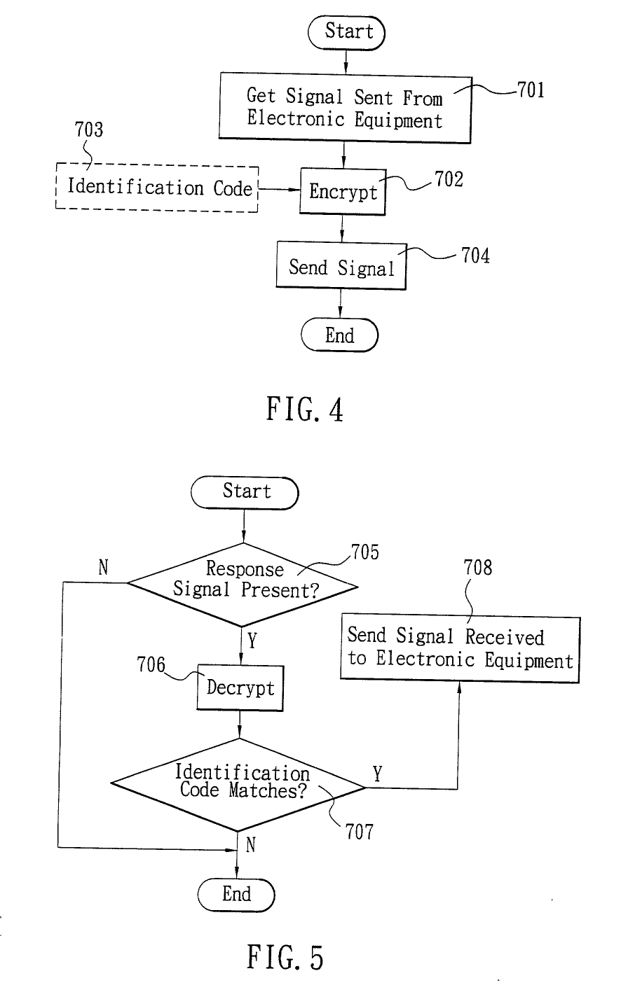

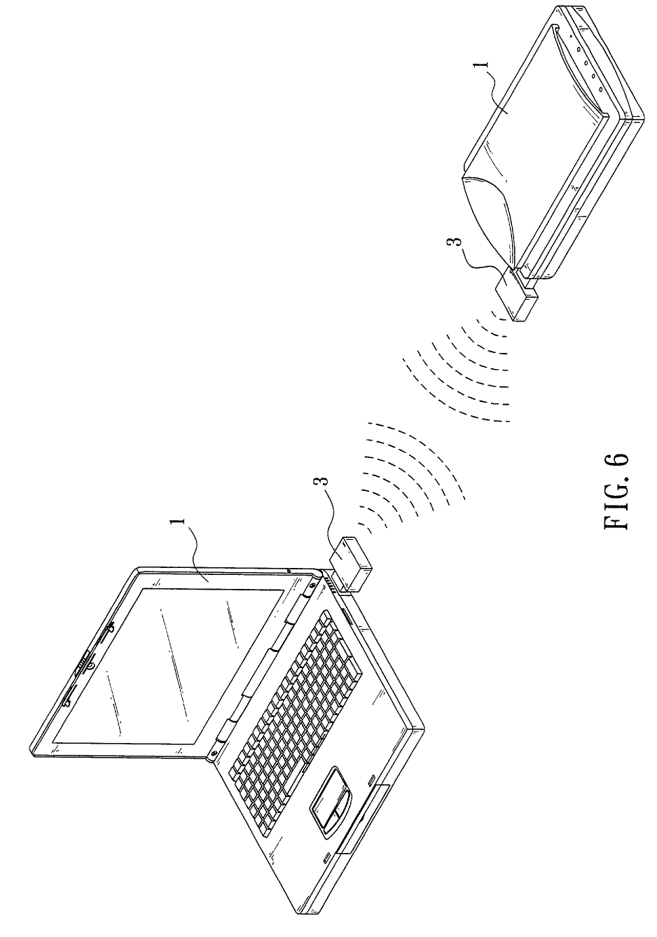

The transmission-reception method for a wireless device of an electronic equipment of the invention herein, referring to FIG. 6, in which the said transmission-reception device 3 connected to the input-output port 10 of a unit of electronic equipment 1 is comprised of a control circuit 30, an encryption-decryption module 31, a wireless transceiver module 32, and a communications plug 33, wherein the said encryption-decryption module 31, wireless transceiver module 32, and communications plug 33 are each respectively wired to the said control circuit 30 (as shown in FIG. 3), and the signal transmission process of the said control circuit 30 is executed according to the steps below (as shown in FIG. 4):

At step 701, the said control circuit 30 of the said transmission-reception device 3 first receives signals from the electronic equipment 1.

At step 702, the said control circuit 30 then utilizes the encryption-decryption module 31 to encrypt signals based on an identification code (such as “A”) preset at step 703 assigned to the transmission-reception device 3 for the said electronic equipment 1.

At step 704, following the completion of encryption, the signals are sent by the wireless transceiver module 32 to a remote transmission-reception device 3 of an identical structure.

The control circuit 30 of the said transmission-reception device 3 executes a signal reception routine (as shown in FIG. 5) according to the steps below:

At step 705, a decision is made as to whether the said wireless transceiver module 32 has received an acknowledgment signal.

At step 706, if the outcome of the said decision is affirmative, the said encryption-decryption module 31 decrypts the said acknowledgment signal.

At step 707, a decision is made as to whether the identification code of the said decrypted acknowledgment signal matches the identification code preset on the said transmission-reception device 3.

At step 708, if the outcome of said decision is affirmative, the decrypted acknowledgment signal is sent to the electronic equipment 1 assigned the said identification code for further processing.

If the outcome of the said decision is negative, the routine is ended.

The routine is also concluded when the said transmission-reception device 3 determines that no acknowledgment signal is present.

As indicated in FIG. 3, the said control circuit 30 of the invention herein is equipped with a central processing unit 301; the said central processing unit 301 is disposed between the said wireless transmission-reception device 3 and the said electronic equipment 1 and processes all commands, data, and signal transmissions, while also handling the operation of all components of the said transmission-reception device 3.

As indicated in FIG. 3, the said wireless transceiver module 32 of the invention herein consists of a transmitter 320 and a receiver 321 that enables signals encrypted by the said central processing unit 301 to be conveyed by the said transmitter 320 to a remote transmission-reception device 3 of an identical structure; in addition, the transmission-reception device 3 is capable of accepting signals from the said receiver 321 and transferring the said signals into the said control circuit 30 for further processing; the said wireless transceiver module 32 utilizes Blue Tooth wireless communications technology for signal transmission and since the said Blue Tooth wireless communications technology is not central to the patent application of the invention herein, it shall not be further elaborated.

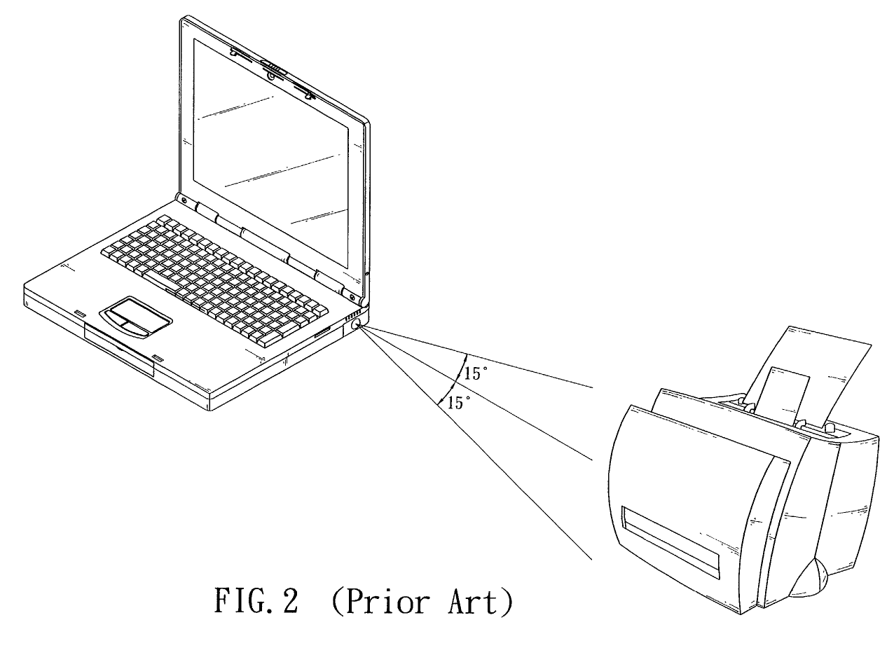

In the invention herein, as indicated in FIG. 2, the other end of the said communications plug 33 wired to the control circuit 30 is in connection with the terminals of a communications card 2; the said communications card 2 has a connector at its opposite end and the said connector is designed to be compatible with various electronic equipment input-output port specifications (such as USB, PS/2, LPT, and other serial device specifications), enabling the said transmission-reception device 3 to be interfaced with a range of different electronic equipment 1 input-output ports 10 simply by replacing the communications card 2 with another model; due to this plug-in interchangeability, projecting technological obsolescence and replacement is no longer a necessary major deliberation and electronic equipment not originally designed with wireless transmission capability can be retrofitted to achieve the objectives of omnidirectional wireless transmission.

As indicated in FIG. 3, the said wireless transmission-reception device 3 of the invention herein has an identification code selector button 34; the said selector button 34 can be a rotary knob, a push-type contact, or other adaptable switch forms through which the said identification code selector key 34 generates differing access configurations and the said transmission-reception device 3 is capable of recognizing the respective identification codes of individual electronic equipment 1 according to the different identification codes so configured; since the each unit of electronic equipment 1 is assigned its own unique identification code, signals outputted from the same single transmission-reception device 3 are correctly addressed to the remote receivers 321 of a plurality of different electronic equipment 1 units without cross talk such that the electronic equipment units are inter-linked into a wireless area network without the use of physical conductors; since the wireless transceiver modules 32 are not affected by signal direction or blocking limitations and capable of both distributed simplex and multiplex omni-directional transmission, they effectively replace confusing, unlabelled data lines and save installation time and cost.

As indicated in FIG. 3, the said wireless transmission-reception device 3 of the invention herein is equipped with a minimum of one indicator light 35; the said indicator light 35 is wired to the said control circuit 30 such that the said control circuit 30 sends different signals to the said indicator light 35 and thereby directs the flashing characteristics of the said indicator light 35, including the intensity, color, and on-off pattern of the said indicator light 35 to display the connection and data transmission status between wireless transmission-reception devices 3.

As indicated in FIG. 3, the said wireless transmission-reception device 3 of the invention herein is equipped with a test button 36; the said test button 36 is wired to the said control circuit 30 such that when the said test button is depressed, the said control circuit 30 generates various signals that are sent to the said indicator light 35 and utilized to govern the flashing characteristics of the said indicator light 35, with the various flashing characteristics used for monitoring the connection and data transmission status between wireless transmission-reception devices 3.

While the invention has been described by means of specific embodiments, numerous modifications and variations could be made thereto by those skilled in the art without departing from the scope and spirit of the invention set forth in the claims.

What is claimed is

1. A transmission-reception method for a wireless device of an electronic equipment, wherein a control circuit of the said transmission-reception device executes a signal reception routine according to the steps below:
first, receiving signals outputted from the electronic equipment by a control circuit of the said transmission-reception device;
utilizing a decryption device of an encryption-decryption module by the said control circuit to encrypt the said signals based on a preset identification code assigned to the said transmission-reception device with respect to the said electronic equipment;
sending the said signals by a wireless transceiver module to a remote transmission-reception device of an identical structure after the completion of encrypting the said signals.

2. As mentioned in claim 1 of the method, wherein the said control circuit of the said transmission-reception device executes a signal reception routine according to the steps below:
first, determining whether the said wireless transceiver module has received an acknowledgment signal.
decrypting the said acknowledgment signal by the said decryption device, if the said wireless transceiver module has received an acknowledgment signal;
determining whether the identification code of the said decrypted acknowledgment signal matches the identification code preset on the said transmission-reception device.
sending the decrypted acknowledgment signal to the said electronic equipment assigned the said identification code for further processing, if the identification code of the said decrypted acknowledgment signal matches the identification code preset on the said transmission-reception device.

3. As mentioned in claim 2 of the method, further comprising the step of ending up the said routine while determining that the said decrypted acknowledgment signal doesn't match the identification code preset on the said transmission-reception device.

4. As mentioned in claim 1 of the method, wherein the said control circuit is wired to a communications plug and the other end of the said communications plug is connected to the said electronic equipment to thereby enable two-way signal exchanges between the said transmission-reception device and the said electronic equipment via the said communications plug.

5. As mentioned in claim 4 the method, wherein the other end of the said communications plug wired to the said control circuit is in connection with the terminals of a communications card and the said communications card has a connector at its opposite end.

6. As mentioned in claim 1 of the method, wherein the said wireless transmission-reception device has an identification code selector button and the said identification code selector button is wired to the said control circuit.

7. As mentioned in claim 1 of the method, wherein the said wireless transmission-reception device is equipped with a minimum of one indicator light; the said indicator light is wired to the said control circuit such that the said control circuit sends different signals to the said indicator light and thereby directs the flashing characteristics of the said indicator light.

8. As mentioned in claim 7 of the method, wherein the said wireless transmission-reception device is equipped with a test button; the said test button is wired to the said control circuit such that when the said test button is depressed, the said control circuit generates different signals that are sent to the said indicator light and utilized to govern the flashing characteristics of the said indicator light.
